(19) United States
(12) Patent Application Publication
(10) Pub. No.: US 2003/0001362 A1
(43) Pub. Date: Jan. 2, 2003

(54) Adjustable height gooseneck coupler

(76) Inventor: Edward Wayne Ebey, Delavan, WI (US)

Correspondence Address: Edgar A. Zarins, Masco Corporation, 21001 Van Born Road, Taylor, MI, 48180, US

(21) Appl. No.: 09/974,035

(22) Filed: Oct. 10, 2001

Related U.S. Application Data
(60) Provisional application No. 60/301,688, filed on Jun. 28, 2001.

(51) Int. Cl. B62D 53/06; B60D 1/00

(52) U.S. Cl. 280/441.2; 280/490.1

(57) ABSTRACT

An adjustable gooseneck coupler for connecting a trailer to a towing vehicle. The trailer includes a front overhang from which the gooseneck coupler depends. The towing vehicle includes a bed having a ball selectively received within a ball housing of the coupler. The gooseneck coupler includes telescopingly adjustable inner and outer tubes to adjust the length of the gooseneck and therefore the height of the trailer overhang relative to the truck bed. The adjustable inner and outer tubes are locked against relative movement by clamping screws. The clamping screws are arranged on the outer tube in longitudinal pairs at a triangular orientation to maximize the clamping force.

### RELATED APPLICATIONS

This application claims priority from U.S. Provisional Application No. 60/301,688 filed on Jun. 28, 2001.

### BACKGROUND OF THE INVENTION

I. Field of the Invention

This invention relates to a coupler for securing a trailer to a towing vehicle and, in particular, to a coupler of a trailer which engages a ball within a truck bed and includes a system for adjusting the length of the coupler to form a level load.

II. Description of the Prior Art

With the increased popularity of recreational vehicles, manufacturers are designing and building vehicles of varying proportions and features. While many recreational vehicles, or trailers, continue to be hitched to the rear end of a towing vehicle through a coupler on the trailer and a hitch on the towing vehicle, larger vehicles have been developed which include a portion extending over the back of the towing vehicle. Examples of such large vehicles include fifth wheel trailers which couple to a specialized hitch mounted within the bed of a pick-up truck and trailers incorporating a gooseneck coupler which is secured to a ball mounted inside the pickup truck bed, usually directly over the rear axle.

However, the over-bed towed vehicles are dependent upon the position or height of the bed of the pick-up truck. Larger pick-up trucks will have a rear bed which is higher than the bed of small trucks. Including four wheel drive capacity to a truck raises the vehicle, and therefore the bed, even further. While these differences are less of a concern in unoccupied recreational vehicles, horse trailers and equipment trailers require a level ride to prevent injury to the animals and prevent shifting of cargo. Even with unoccupied trailers, adjustment may be desirable to ensure the trailer will be towed at the correct towing angle for uniform weight distribution.

### SUMMARY OF THE PRESENT INVENTION

The present invention overcomes the disadvantages of the prior couplers by providing a gooseneck coupler which can be adjusted in length to adjust the height of the towed vehicle when coupled to the towing vehicle.

The adjustable gooseneck coupler of the present invention is adapted for use with trailers having a portion or front end which is designed to extend over the cargo bed of a towing vehicle. The rear of the trailer is supported by one or more axles such that the trailer will be towed or pulled down the road by the towing vehicle. Extending downwardly from the front overhang of the trailer is a gooseneck coupler embodying the present invention. The gooseneck coupler is fixedly secured at its upper end to the trailer and includes a coupler assembly at its lower end for releasably engaging a ball mounted within the cargo bed of the towing vehicle. The coupler assembly includes a housing for rotatably receiving the ball allowing the truck and trailer to pivot during turns. A lock selectively secures the ball within the housing to prevent separation of the gooseneck coupler from the ball mounted within the truck. The lock is releasable to facilitate separation of the trailer from the towing vehicle.

The gooseneck coupler of the present invention is adjustable so as to vary its length and therefore the distance between the trailer overhang and the coupler assembly which must be secured to the truck bed. The coupler includes telescoping inner and outer tubes. The inner and outer tubes are locked at the desired length by a plurality of clamping screws which extend through the wall of the outer tube to selectively engage the inner tube. Tightening of the clamping screws pushes the inner tube against the opposite side of the outer tube to prevent telescoping movement of the inner tube relative to the outer tube. In a preferred embodiment of the present invention, two pairs of longitudinally aligned clamping screws are employed to form a triangular clamping in conjunction with the opposite wall of the outer tube. The two sets of screws are spaced approximately 120° apart to create the triangulation. This orientation of the clamping screws provides improved retention and less deformation of the inner tube and screws.

The length of the coupler may be adjusted by loosening the clamping screws allowing the inner tube to move freely within the outer tube. At the desired position, the screws are tightened to prevent relative movement. This adjustment allows the trailer overhang to be leveled no matter what the height of the truck bed may be to ensure level towing.

Other objects, features and advantages of the invention will be apparent from the following detailed description taken in accordance with the accompanying drawings.

### BRIEF DESCRIPTION OF THE DRAWING

The present invention will be more fully understood by reference to the following detailed description of a preferred embodiment of the present invention when read in conjunction with the accompanying drawing, in which like reference characters refer to like parts throughout the views and in which:

FIG. 1 is a perspective view of a towing vehicle connected to a trailer incorporating an adjustable gooseneck coupler embodying the present invention;

FIG. 2 is a partial perspective view of the adjustable gooseneck coupler;

FIG. 3 is a perspective view of the outer tube carrying the clamping screws;

FIG. 4 is a transverse cross-sectional view taken along lines 4-4 of FIG. 1;

FIG. 5 is a side view of the outer tube;

FIG. 6 is a first side view of the inner tube;

FIG. 7 is a second side view of the inner tube; and

FIG. 8 is a transverse cross-sectional view taken along lines 8-8 of FIG. 7.

### DETAILED DESCRIPTION OF A PREFERRED EMBODIMENT OF THE PRESENT INVENTION

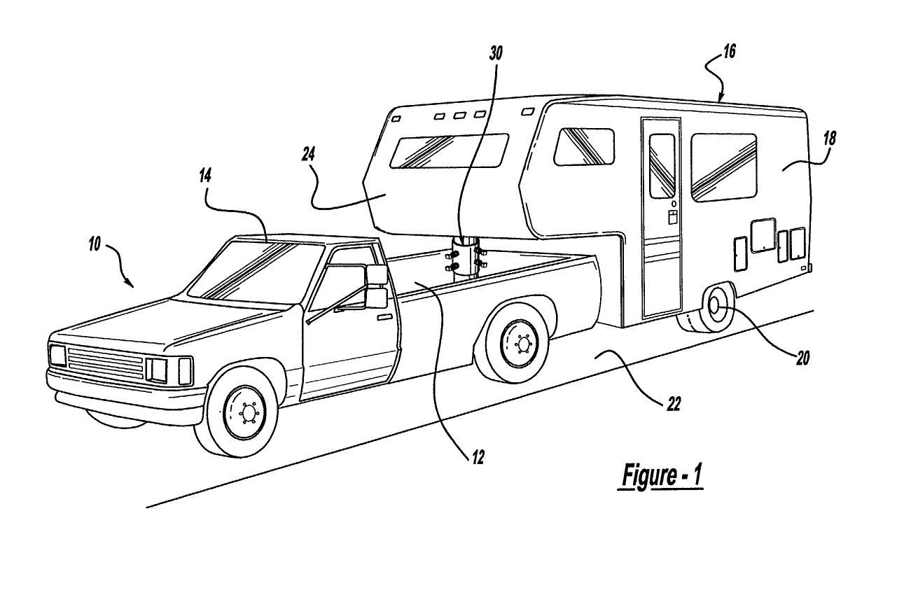

Referring first to FIG. 1, three is shown a towing vehicle 10, such as a pick-up truck having a cargo bed 12 and a passenger cab 14, and a trailer 16 adapted to be towed by the vehicle 10. The trailer 16 includes a housing compartment 18 supported on at least one set of wheel axles 20 to roll along the road 22. The trailer 16 of the present invention has an overhanging portion 24 which extends above the truck cargo bed 12 when the vehicles 10,16 are coupled. The truck bed 12 includes a hitch ball 26 or similar structure for detachably receiving a gooseneck coupler 30 in accordance with the present invention. It is desirable that the towed vehicle 16 be maintained level to the road 22 when coupled to truck beds 12 of different heights and the gooseneck coupler 30 is adjustable in length to achieve this purpose.

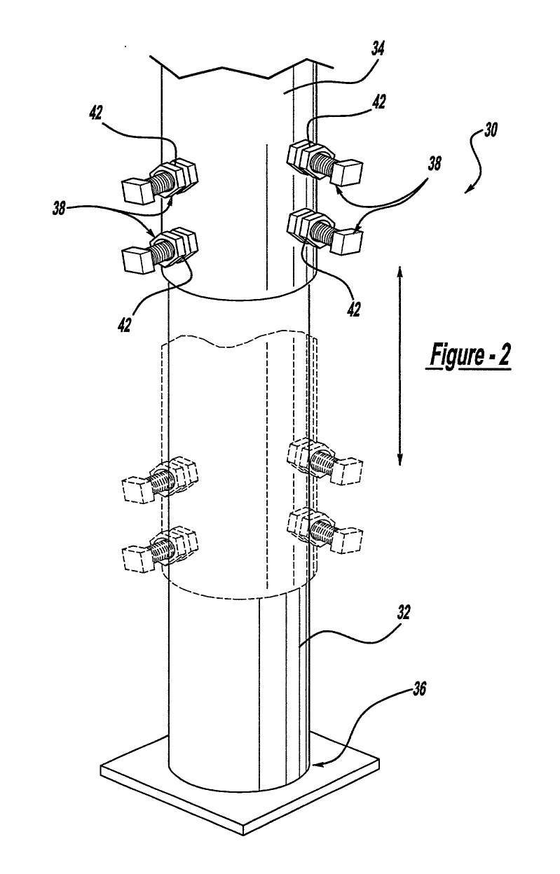

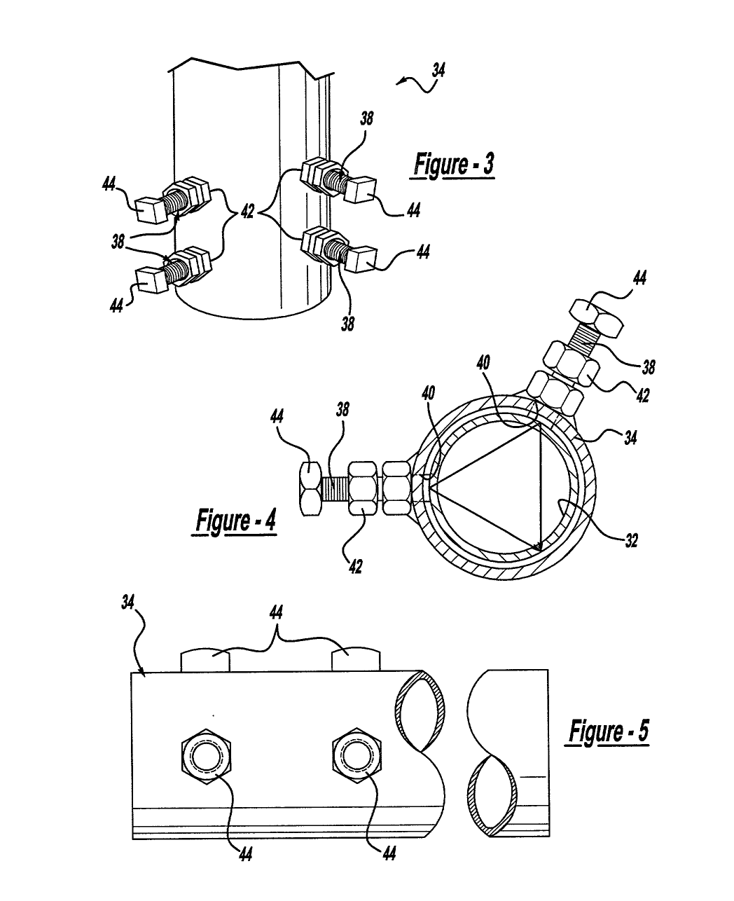

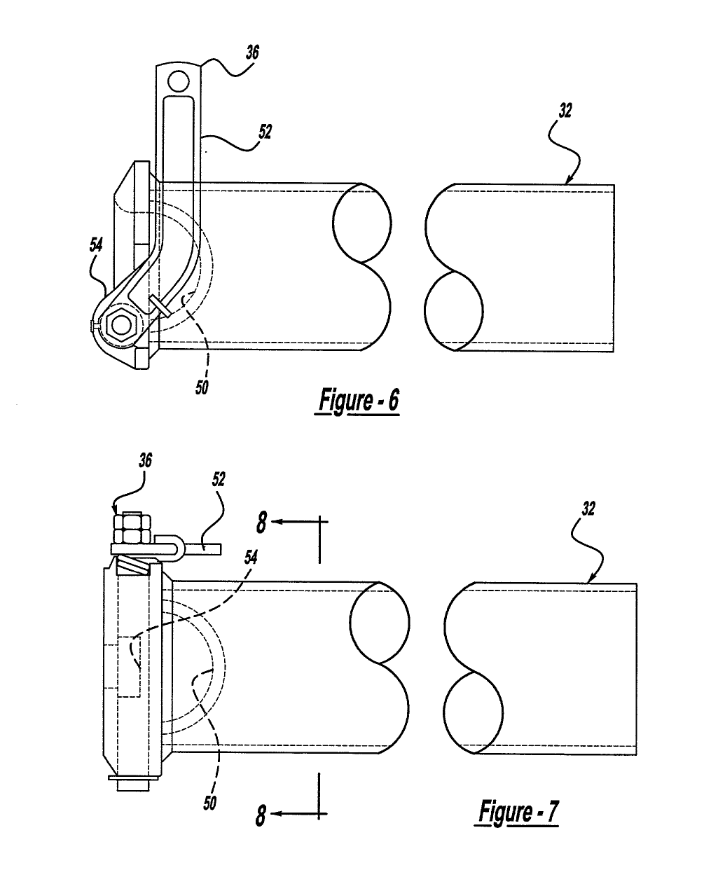

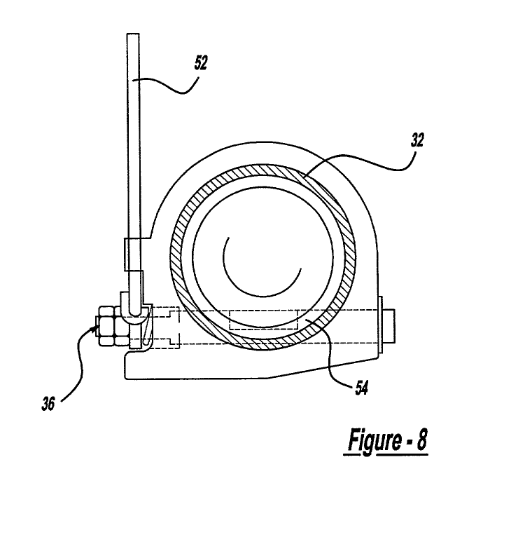

Referring now to FIGS. 2 through 8, the gooseneck coupler 30 of the present invention includes a pair of telescoping tubes—inner tube 32 and outer tube 34. Outer tube 34 is fixedly attached to the underside of the trailer overhang 24. The inner tube 32 received within the outer tube 34 includes a coupler assembly 36 at the lower end of inner tube 32. The coupler assembly 36 is utilized to detachably couple the trailer 16 to the towing vehicle 110 as will be subsequently described.

In order to secure the telescoping gooseneck coupler 30 at a predetermined length, a series of clamping screws 38 are mounted to the outer tube 34. The prior art telescoping couplers would utilize only a single clamping screw to prevent relative movement of the tubes. The present invention contemplates clamping screws 38 at offset orientation to create a triangular clamping force. In a preferred embodiment, the outer tube 34 carries two pairs of clamping screws 38 offset on the periphery of the outer tube 34 to create the triangulation. One such orientation is a 120° offset to form an equilateral triangulation.

The outer tube 34 includes a corresponding number of apertures 40 with threaded nuts 42 welded in alignment therewith. The clamping screws 38 are threadably received within the nuts 42 for movement into and out of the apertures 40. The clamping screws 38 include heads 44 for manipulation by an appropriate tool (not shown). Rotation of the screws 38 in a first direction will cause the screws 38 to move radially inwardly into locking engagement within the inner tube 32. Rotation of the screws 38 in a second opposite direction will cause the screws 38 to move radially outwardly freeing the inner tube 32 for movement relative to the outer tube 34 and adjustment of the length of the gooseneck coupler 30. To prevent relative movement of the tubes, the clamping screws 38 should be moved radially inwardly to engage and push on the inner tube 32. The clamping screws 38 are tightened sufficiently to push the inner tube 32 against the opposite side of the outer tube 34 creating the triangular clamping force depicted in FIG. 4. In this manner, the inner tube 32 and the outer tube 34 can be locked together at the desired position to form a gooseneck coupler 30 of the required length.

The gooseneck coupler 30 of the present invention connects the trailer 16 to the towing vehicle 10 such that the trailer 16 is maintained in a substantially level position. The length of the gooseneck coupler 30 is adjusted so that it spans the distance between the underside of the trailer overhang 24 and the normal position of the truck bed 12. The truck 10 is backed beneath the overhang 24 until the hitch ball 26 aligns with the gooseneck coupler 30. In one embodiment of the coupler assembly 36, the ball 26 is positioned within a housing 50 having a semi-spherical configuration. Once the ball 26 is nested within the coupler housing 50, a coupler handle 52 is pivoted to deploy a latch member 54 against the hitch ball 26 and prevent its withdrawal from the housing 50. Movement of the handle 52 in the opposite direction will release the hitch ball 26 for withdrawal of the gooseneck coupler 30 and separation of the towing vehicle 10 from the trailer 16. Thus, the adjustable gooseneck coupler 30 of the present invention facilitates towing of the trailer 16 at a level position while also providing simple disconnection of the trailer 16 from the towing vehicle 10.

The foregoing detailed description has been given for clearness of understanding only and no unnecessary limitations should be understood therefrom as some modifications will be obvious to those skilled in the art without departing from the scope and spirit of the appended claims.

1. An adjustable gooseneck coupler adapted to be fixedly secured to a trailer for selective coupling engagement with a towing vehicle, said coupler comprising:
a first elongated member secured to the trailer;
a second elongated member telescopically engaging said first elongated member for adjustment of the length of said coupler;
means for locking said first and second elongated members against telescoping movement to fix said length of said coupler; and
a coupler assembly mounted to a lower end of said second elongated member for selective coupling engagement with the towing vehicle.

2. The coupler as defined in claim 1 wherein said means for locking said first and second elongated members against telescoping movement includes a plurality of clamping members mounted on one of said first and second elongated members for locking engagement with an other of said first and second elongated members.

3. The coupler as defined in claim 1 wherein said first elongated member is an outer tubular member and said second elongated member is an inner tubular member telescopically received within said outer tubular member.

4. The coupler as defined in claim 3 wherein said means for locking includes two pairs of clamping members mounted to said outer tubular member for selective locking engagement with said inner tubular member.

5. The coupler as defined in claim 4 wherein said pairs of clamping members are circumferentially spaced along the periphery of said outer tubular member.

6. The coupler as defined in claim 5 wherein said pair of clamping members are spaced 120° along the periphery of said outer tubular member.

7. The coupler as defined in claim 5 wherein said clamping members are clamping screws extending through a wall of said outer tubular member for selective engagement with said inner tubular member.
